(19) United States
(12) Patent Application Publication
(10) Pub. No.: US 2006/0076099 A1
(43) Pub. Date: Apr. 13, 2006

(54) Safety pneumatic tire for the biclycle

(76) Inventors: Hsu Shwu Kuo, Sugar Land, TX (US); Ming-Che Hsu, Yen-Lin (TW)

Correspondence Address: Hsu S. Kuo, 3110 W. Autumn Run Cir, Sugar Land, TX, 77479, US

(21) Appl. No.: 10/964,447

(22) Filed: Oct. 13, 2004

(51) Int. Cl. B60C 5/00

(52) U.S. Cl. 152/516

(57) ABSTRACT

The object of this invention is to provide a safety pneumatic tire for the bicyclist. The new safety pneumatic tire comprises an improved outer cover (or tire) and an improved inner tube. The improved inner tube is incorporated inside the improved tire and both are mounted on a tubeless rim (rather than a traditional rim). A) The improved tire consists of an elastomeric material coating that is applied to the beads of the tire to obtain an elastic property. The elastomeric-covered beads and the tubeless rim naturely join closely to form a completely sealed chamber between the tire and the tubeless rim. B) The improved inner tube consists of an elastic rubber part that is added to the outer base of the air valve body or is added to the entire outer body of the air valve to form an air tight seal with the rim valve opening. The joints and the connections between the improved tire, the improved inner tube and the tubeless rim are tightly sealed to form an enclosed chamber so that, if the inner tube is punctured, the compressed air remains inside the enclosed chamber and does not immediately deflate. As a result, any deflation of tire occurs slowly and the bicyclist is protected from falling and is able continue riding. The present invention is also able to avoid the difficulty of air inflation which exists in tubeless tires. In tubeless tires, if inflation of the tire is not rapid enough to create sealing pressure between the tire beads and the tubeless rim bead seat, air will escape during the process of inflation. With the present invention, this difficulty is avoided with the use of the improved inner tube.

### BACKGROUND OF THE INVENTION

A) Field of Invention

The present invention relates to a pneumatic tire assembly for the bicycle. This invention especially relates to an improved outer tire and improved inner tube for a pneumatic tire assembly that provides protection against immediate or rapid deflation of the tire when the inner tube is punctured and also allows for easy air inflation of a pneumatic tire by a bicyclist.

B) Description of the Prior Art

The typical bicycle pneumatic tire assembly comprises a traditional tire, a traditional inner tube and a traditional rim. Both the tire and the inner tube are mounted on the corresponding rim. The traditional inner tube comprises a toroidal elastic tube with a traditional air valve. When the inner tube is inflated with the compressed air, the wheel performs the function of providing the bicycle and its load with a pneumatic-type support, and ensures suitable behavior on the road. The deficiency of the traditional inner tube is that when it is torn or punctured, the compressed air inside the inner tube then leaks through the broken hole of the inner tube and escapes through the rim valve hole and rim spoke openings and the gaps between the tire beads and rim bead seat. The result is an immediate deflation of the tire and corresponding loss of stability of the bicycle. The rider's safety in such an event at serious risk.

The reasons for this immediate deflation of a typical tire assembly primarily relate to three sealing problems. First, the beads of a traditional tire does not have elastomeric covering so that the contact between the beads of the tire and the rim bead seats is loose which allows compressed air to escape. Second, the traditional rim of a typical tire assembly has numerous unsealed spoke openings on the central annular channel to accommodate the spokes of the wheel. Compressed air then also escapes through these spoke openings. Third, the air valve of the traditional inner tube is purposefully not integrated with the rim valve opening so that air between the inner tube and tire may escape as the inner tube is inflated. This way, air is not trapped in the cavity between the inflated inner tube and the tire and close contact between the inflated inner tube and tire is achieved. Therefore, because above described sealing problems in a typical tire assembly, the volume between the tire and the inner tube is not totally separated from surrounding enviroment and compressed air may leak into the atmosphere of the surrounding enviroment once the inner tube is punctured or torn.

FIG. 1 illustrates what happens when a traditional inner tube is punctured by a sharp object (70). The pressurized air leaks out from the puncture hole (21) and flows into the cavity (23) which is surrounded by the tire (10), inner tube (20) and the rim (40). Thereafter, the pressurized air quickly leaks to the atmosphere of surrounding environment through the spoke openings (45) and the gaps (13) between beads of the tire and the rim bead seats.

FIG. 2 illustrates another location (different from FIG. 1 shows) for pressurized air to escape into the atmosphere when the traditional inner tube is punctured by a sharp object (70). The pressurized air leaks out from the puncture hole (21) and flows into the cavity (23) which is surrounded by the tire (10), inner tube (20) and the rim (40). Thereafter, the pressurized air quickly leaks into the atmophere of surrounding environment through the gap (44) between the valve body (32) and the rim valve hole (43).

By comparison, the tubeless tire is deemed to be much safer than the typical tire assembly with the traditional tire, inner tube and rim. The tubeless tire and tubeless rim have become a popular assembly for bicycles. However, the requirement for bicycle tires is to be lightweight, so the structure of the tubeless tire is quite thin, especially at the tire beads. As a result, the beads of the tubeless tire easily deform, causing a gap between the tire beads and the rim bead seats and giving rise to a sealing problem. The volume of the air which is blown into the tubless tire by the pump gradually escapes at various points where the beads have deformed. This problem becomes especially apparent when the tubeless tire is inflated with a manual pump since the rate of inflation and increase in volume of air in the tire are not quick enough to apply sufficient pressure against the tire beads to seal the gaps. So far, there is no effective solution to correct this problem

### SUMMARY OF THE INVENTION

The purpose of the invention is to propose a safety pneumatic tire for the bicycle to ensure the bicyclist's safety in case the inner tube is punctured. The invention will also allow easy air inflation of the tire for the bicyclist.

The invention is related to a pneumatic safety tire that comprises an improved tire (outer cover) and an improved inner tube that is incorporated inside the improved tire, both of which are mounted on a tubeless rim.

A) The improved tire consists of an elastomeric material coating that is applied to the beads of the tire to obtain an elastic property. The elastomeric-covered beads and the tubeless rim naturely join closely to form a completely sealed chamber between the tire and the tubeless rim. In case the inner tube is punctured, the pressurized air remains in the tire and the pressure of inflation is maintained.

B) The improved inner tube consists of an elastic rubber part that is added to the outer base of the air valve body or is added to the entire outer body of the air valve to form an air tight seal with the rim valve opening. The elastic rubber covered air valve is fastened to the rim valve opening of the tubeless rim.

The advantages of the invention is to provide a completely closed and sealed chamber between the pneumatic tire and upper bridge of tubeless rim which has no spoke holes except a valve hole. The inflated improved inner tube presses against the improved tire (outer cover) and the tire beads are tightly fixed on the bead seats of the tubeless rim. When the improved inner tube is punctured, the pressurized air escapes from the inner tube but is confined in the closed and sealed chamber between the improved tire and the upper bridge of the tubeless rim. Therefore, pressure is maintained within the improved tire and the bicyclist then is able to continue riding without risk of falling. Also, a further advantage of the invention is that it allows for easy inflation by a manual pump, even a mini manual pump, as compared to the tubeless tire since the process and rate of inflation is not hampered by leakage of compressed air through gaps between the tire beads and the rim bead seats during the inflation process, which is the situation with the tubeless tire. Instead, it is the improved inner tube that is inflated, which is a sealed, closed system that can be easily inflated with any manual pump. So, unlike the tubeless tire, the invention does not require rapid pressurization of the tire to create the necessary seal between the tire beads and bead seats to avoid leakage during the inflation process.

### BRIEF DESCRIPTION OF DRAWINGS

A) The drawings:

The invention will be better understood with reference to the following description and the attached drawings.

FIG. 1 illustrates a typical pneumatic tire in which the inflated inner tube is punctured by a sharp object. The compressed air leaks into the cavity between the outer cover (tire) and the inner tube. The air then escapes to the atmosphere through the spoke holes and the gaps between the tire beads and the rim bead seats.

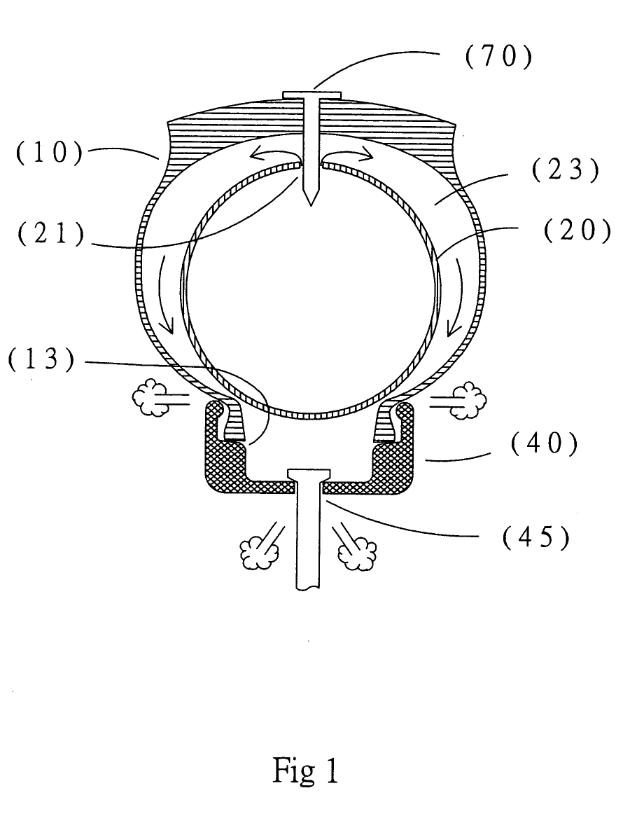

FIG. 2 illustrates the typical pneumatic tire in which the inner tube is punctured by a sharp object and the compressed air leaks into the cavity between the outer cover (tire) and the inner tube. The air then escapes to the atmosphere through the rim valve opening and the gaps between the tire beads and the rim bead seats.

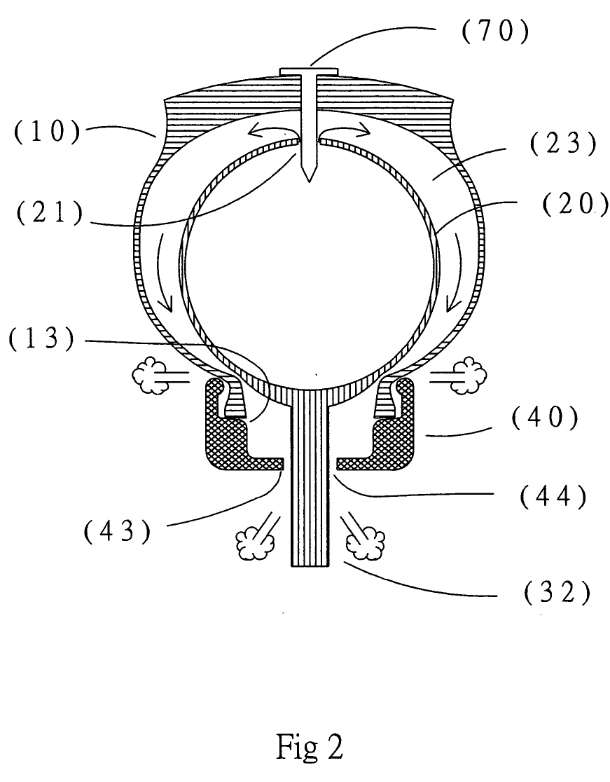

FIG. 3 illustrates the structure of the safety pneumatic tire with improved parts that includes an improved tire, an improved inner tube which connects to a semi-elastic rubber-covered air valve and a tubeless rim. The connection between the improved inner tube and the semi-elastic rubber-covered air valve may also be vulcanized.

FIG. 4 illustrates the finished assembly state of the safety pneumatic tire in its inflated phase, referring to FIG. 3.

FIG. 5 illustrates phase when the improved inner tube of the safety pneumatic tire is punctured. The compressed air leaks out the improved inner tube but is kept in the sealed and closed chamber between the improved tire and the tubeless rim.

FIG. 6 illustrates the structure of the safety pneumatic tire with a different assembly of parts that includes an improved tire, improved inner tube which attachs an air valve (made of metal, plastic, composite or other material with sufficient hardness and body) with a elastic rubber ring, and the tubeless rim.

FIG. 7 illustrates the finished assembly state of an safety pneumatic tire in its inflated phase, referring to FIG. 6.

FIG. 8 illustrates the structure of an safety pneumatic tire with another type of assembly parts that included an improved tire, improved inner tube which connects an elastic rubber covered air valve and a tubeless rim. The connection between the improved inner tube and the semi-elastic rubber-covered air valve may also be vulcanized.

FIG. 9 illustrates the completed assembly state and inflated phase of the improved tire, referring to FIG. 8.

B) The key for drawings:

(10) Outer cover (tire)
(11) Beads
(12) Elastomeric layer
(13) Bead-gaps
(20) Inner tube
(21) Broken hole of inner tube
(22) Pressurized air
(23) Volume between inner tube and tire
(24) Inner tube air hole
(25) Thickened air hole surrounding edge or rubber ring
(30) Elastic rubber semi-covered air valve
(31) Elastic rubber covered valve base
(32) Valve body
(33) elastic rubber covered section
(34) Spiral threads
(35) Washer
(36) Nut
(40) Tubeless rim
(41) Rim beat-seats
(42) Rim valve hole
(43) Valve hole periphery
(44) Gap between valve hole and valve body
(45) Spoke holes
(50) Metallic air valve
(51) Base of air valve
(52) Valve body
(53) Cup-shaped ring piece
(54) Spiral threads
(55) Washer
(56) Nut
(60) Elastic rubber covered air valve
(61) Valve base
(62) Valve body
(63) Diameter enlarged section
(70) Sharp object

### DETAILED DESCRIPTION OF INVENTION

The invention is described in detail and refers to the drawings. The emphasis is on the structure of assembly, the technique and the achievement of the desired result.

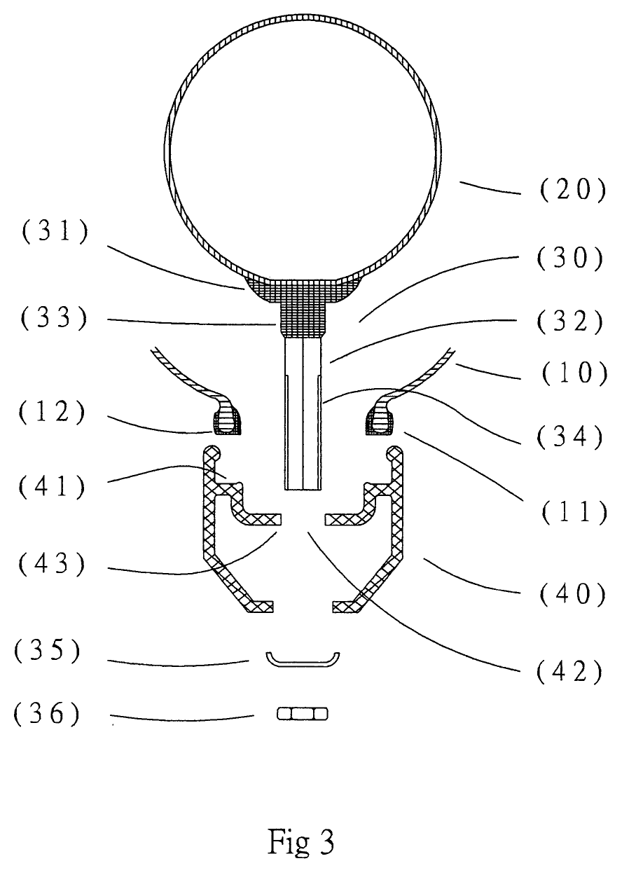

The function of the safety pneumatic tire is illustrated in FIGS. 3, 4 and 5.

FIG. 3 displays all the parts that are to be assembled for the safety pneumatic tire. The improved tire (10) has beads (11) that are coated with an elastomeric layer (12). These coated beads (11) are mounted on the bead-seats (41) of the tubeless rim (40). The natural elasticity of the elastomeric material coating (12) naturally ensures a close contact of the tire beads with the rim bead seats (41), which forms an airtight chamber.

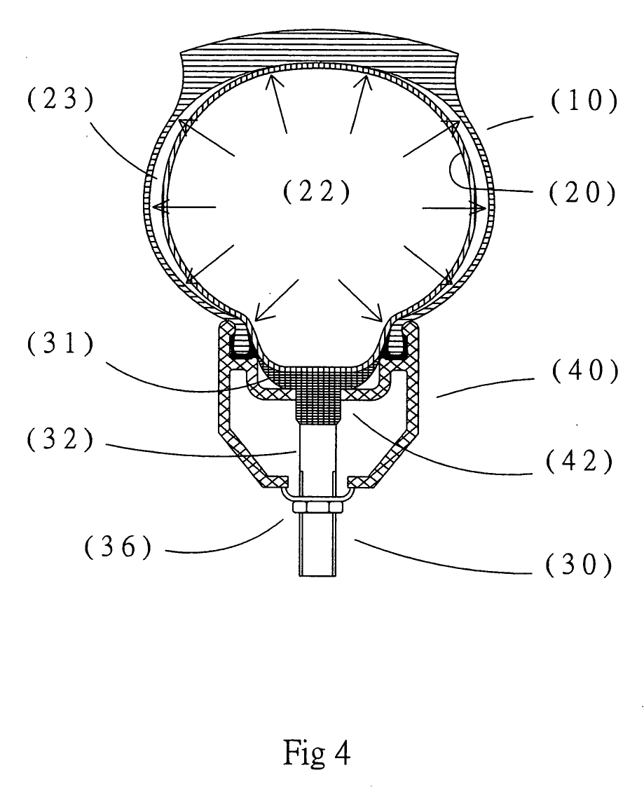

In addition, the elastic rubber-covered valve base (31) of the elastic rubber semi-covered air valve (30) is united (using a process of vulcanization or use of an adhesive) with the inner tube (20) to make the improved inner tube which is incorporated inside the improved tire (10). Where the valve body (32) is connected to the elastic rubber-covered valve base (31), there is a elastic rubber covered inserted section (33). The valve body (32) is inserted through the valve opening (42) of the tubeless rim (40). The elastic rubber semi-covered air valve (30) is tightly pressed into the valve hole (42) by screwing in the nut (36) and washer (35) at the thread end (34) of the valve body (32) at outer side of the tubeless rim (40). The diameter of the elastic rubber-covered inserted section (33) of the valve body is greater than the inner diameter of rim valve opening (42). The process of tightening the elastic rubber semi-covered air valve (30) pushes the elastic rubber covered inserted section (33) into the rim valve opening (42) to achieve a tight seal between elastic rubber semi-covered air valve (30) and the rim valve opening (42) (as FIG. 4 illustrated). Please note that the mechanical process of tightening using a nut (36) and washer (35) onto a threaded valve body (34) is not the only means of achieving a tight seal and any other mechanical means to achieve sufficient tightening may also be used. Therefore, the assembly of the improved inner tube (20) with elastic rubber semi-covered air valve (30) and the rim valve opening (42) allows for and provides a tight sealing function, irrespective of any change or alteration in the shape or structure the air valve.

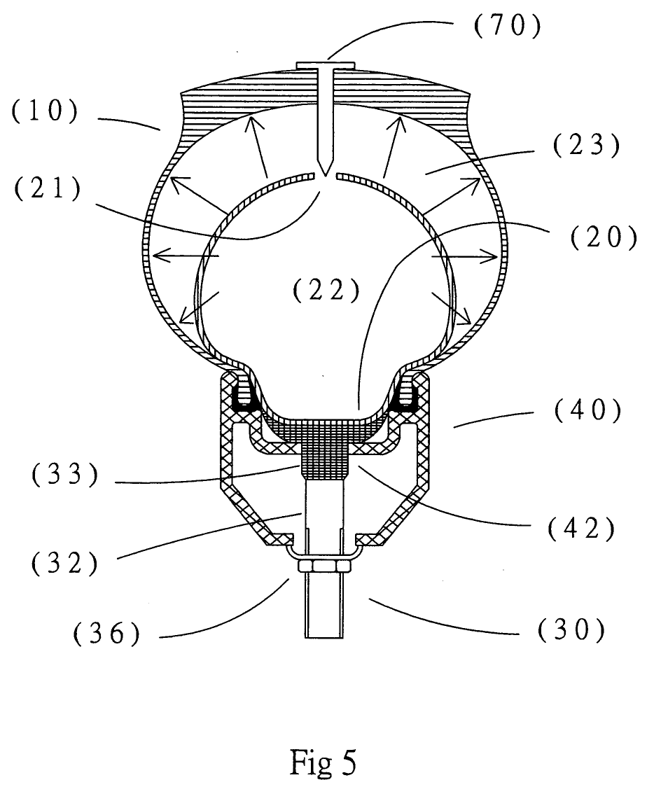

FIG. 4 shows the fully-assembled safety pneumatic tire and its sealing mechanism. The inflated inner tube (20), which is incorporated inside the improved tire (10), presses the air that is trapped in the cavity (23) between the inner tube (20) and the improved tire (10), until the pressure of the air in the cavity (23) is finally equivalent to the pressure of the compressed air (22) in the inner tube (20). As shown in FIG. 5, when the improved inner tube is punctured by a sharp object (70) and the compressed air (22) leaks out from the inner tube (20), the compressed air is confined in the sealed and enclosed chamber between the improved tire (10) and the tubeless rim (40). Thus, the pressure of the safety pneumatic tire is securely maintained.

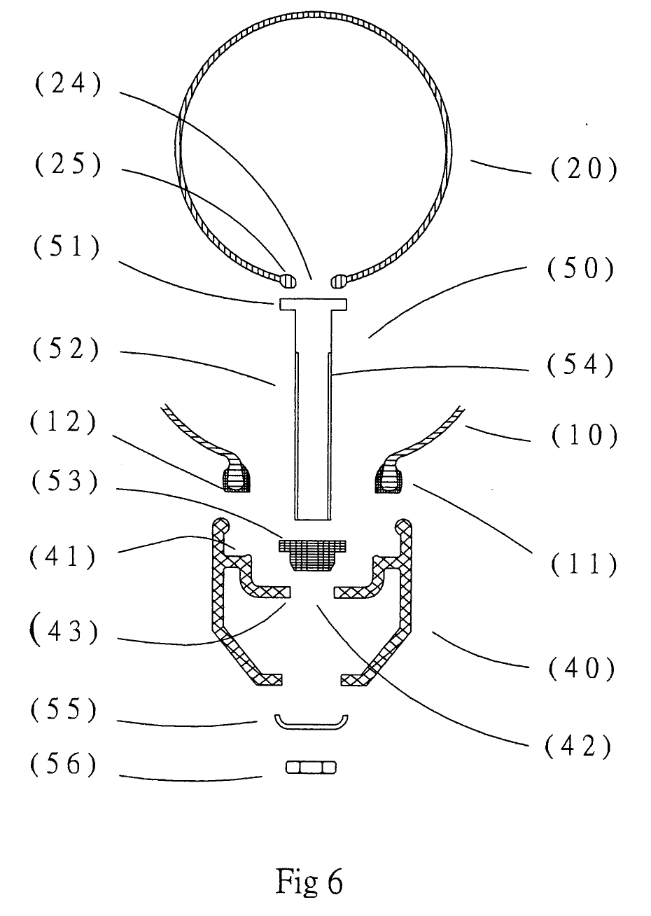

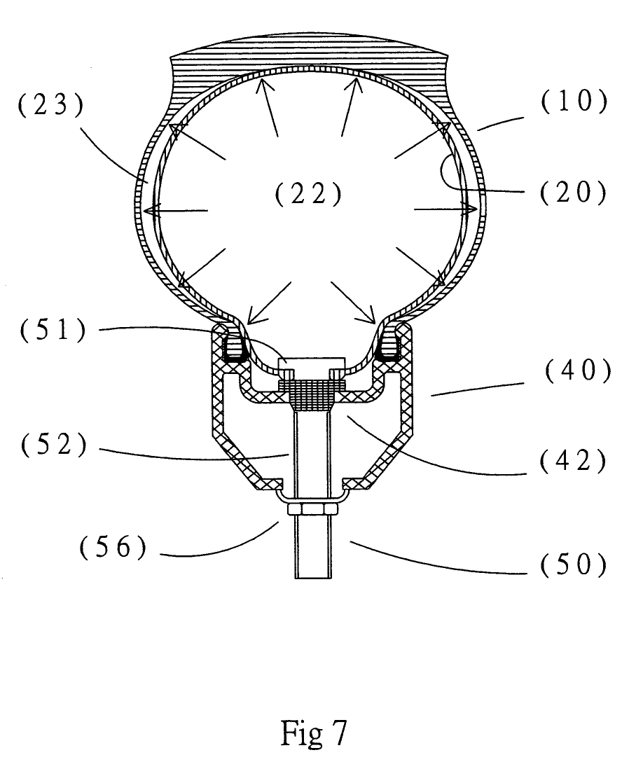

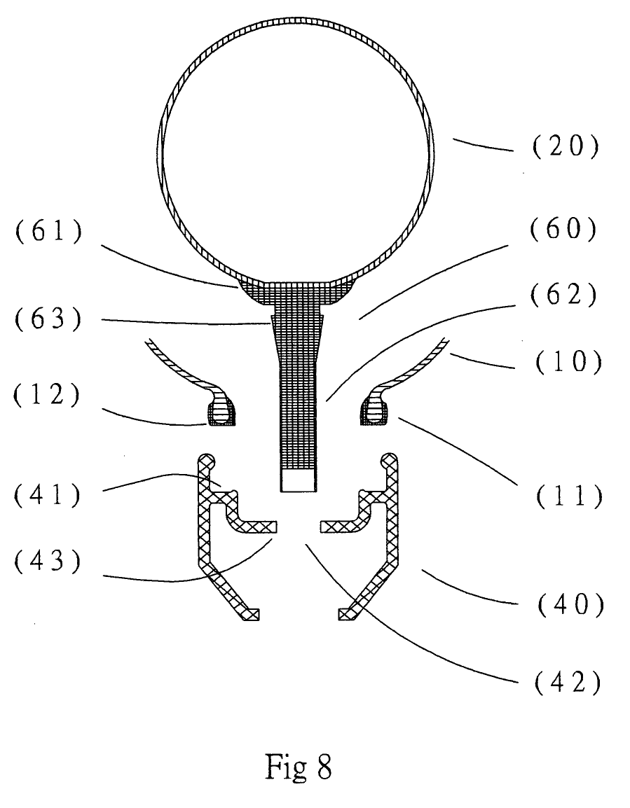

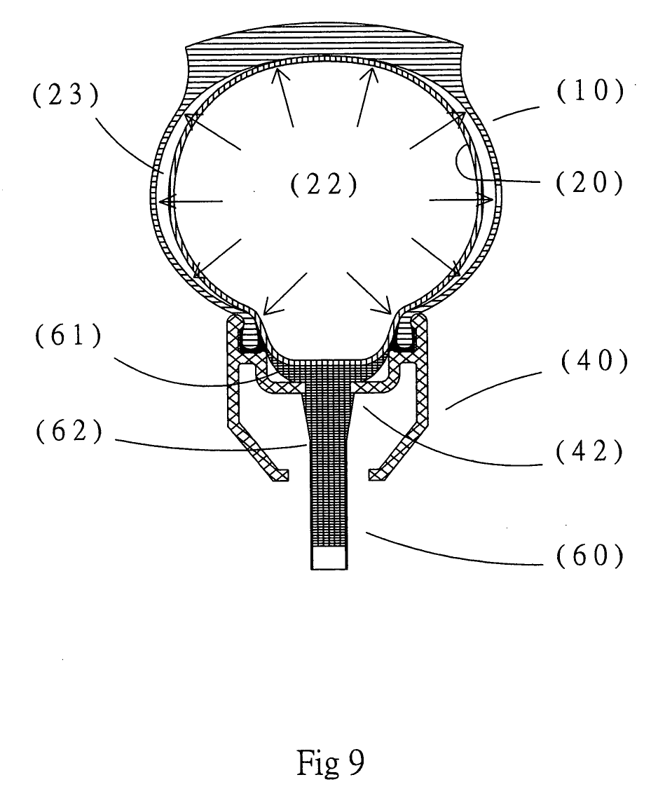

The use of elastic rubber semi-covered air valve (30) united (using a process of vulcanization or use of an adhesive) with the inner tube to make the improved inner tube (as illustrated in FIGS. 3 and 4) is not restrictive. Other methods of obtaining an effective sealing structure between the air valve of inner tube and rim valve opening may be used as non-restrictively illustrated in other included drawings. FIG. 6 and FIG. 8 show the assembly structure of possible alternative methods and FIG. 7 and FIG. 9 show the inflated phase of the completed assembly using each of those methods, respectively.

FIGS. 6 and 7 show an alternative approach to assemblying the improved inner tube through use of an air valve that is not united (through vulcanization or use of an adhesive) with the inner tube and achieving an airtight seal between the improved tire, improved inner tube and the tubeless rim. In FIG. 6, the valve base (51) of such non-united air valve (50) (which may be made of metal, plastic, composite or other material with sufficient hardness and body) is inserted through the tube air hole (24) of the inner tube (20) and anchors to the inner tube at the inner wall of the inner tube. To achieve sufficient anchoring, the diameter of the valve base (51) should be greater than the inner diameter of the tube air hole (24) and also greater than the inner diameter of the rim valve hole (42).

In order to create an airtight seal between the the inner tube, such non-united air valve and the rim, the surrounding edge (25) of the tube air hole (24) should be thicken or an elastic rubber O-ring (25) should be added to the air valve base (51) between the air valve base and the interior of inner tube at the periphery of the tube air hole. A tightly fitted elastic rubber ring piece (53) should be added on the exterior of the valve body (52) at the section close to the valve base (51) but on the external side of the inner tube at the periphery of to the tube air hole. Such elastic rubber ring piece to be added to the exterior of the valve body may be cone-shaped, nipple-shaped or other appropriate shape to ensure sealing between the valve body and the rim valve hole.

When the valve body (52) of the air valve (50) is inserted through the rim valve hole (42), the tightly fitted elastic rubber ring piece (53) is pushed in and form an inital close contact with the valve hole periphery (43). An airtight seal between the air valve (50), the inner tube (20) and tubeless rim (40) is formed by screwing the nut (56) and the washer (55) on the threaded (54) end of the valve body (52) from outer side of the tubeless rim (40) which causes the valve base (51) of the air valve (50) and the valve hole periphery (43) to forcefully clamp the thickened elastic rubber ring (25) of the inner tube (or the elastic rubber O-ring (25)) and the tightly fitted elastic ring piece (53). FIG. 7 illustrates the inflated state of the final assembly using non-united air valve (50), the thickened elastic rubber ring (25) of the inner tube and the tightly fitted elastic ring piece (53). In this manner, the assembly between the the air valve (50), the inner tube (20) and tubeless rim (40) achieves the function of tight seal, irrespective of and without specificity to the structure or shape of the air valve.

FIGS. 8 and 9 illustrate the safety pneumatic tire utilizing an alternative structure for the improved inner tube that does not rely upon a mechanical process for tightening applied at the valve body. In FIG. 8, the valve base (61) of rubber covered air valve (60) is united (through vulcanization or use of an adhesive) with inner tube (20) to form one unit. The diameter of the elastic rubber covered section (63) of the valve body (62) next to the valve base (61) is enlarged and a notch above the valve base (61) is formed. The notch in the diameter enlarged section (63) of the valve body (62) provides for secure positioning of the valve body (62) with the rim valve hole (42) and for tight sealing of the improved inner tube (20) with the tubeless rim (40).

The valve body (62), with the notch, is inserted through the valve hole (42) and the enlarged section (63) is squeezed tightly into the valve hole periphery (43) to the point of the notch in order to obtain a tight seal. In addition, the notch formed on the diameter enlarged section (63) next to the valve base (61) ensures that the valve body (62) is securely positioned and fastened to the valve hole (42). FIG. 9 illustrates the inflated state of the final assembly using the alternative structure for the improved inner tube that does not rely upon a mechanical process for tightening applied at the valve body to achieve tight sealing of the improved inner tube with the tubeless rim and the secure positioning of the valve body with the rim valve hole.

As provided in the descriptions and drawing referred to above (which intended to serve as examples, and one could adopt variations thereof without leaving the scope of the invention), the present invention provides a better engineering design and better structure to traditional bicycle tire. In other words, the non-airtight assembly structure of the traditional tire, specifically referring to the juncture of the tire beads and bead-seats and the juncture of the air valve and valve hole, are replaced with the airtight assembly structure to provide a dependable airtight sealing mechanism for retaining of the compressed air at the time the inner tube is punctured.

In addition, the total weight of the safety pneumatic tire is comparable to the the weight of a traditional tire or the weight of a tubeless tire for a bicycle, so there is little, if any, additional weight for the bicyclist. Finally, the production and manufacturing techniques for the present invention can adapted from the existing techniques for traditional tires so no new manufacturing facilities and techniques are needed.

In conclusion, the present invention is intended to accomplish the goal of overcome the short-comings of the traditional tire described previously in an economical and efficient manner that can be easily and practically employed in a production manufacturing setting. The assembly of the safety pneumatic tire, which comprises an improved inner tube, improved tire and tubeless rim, provides a mechanism for confining compressed air inside the improved tire. When the improved inner tube is punctured, the compressed air is retained in the chamber within the improved tire without immediate or rapid loss of air pressure in the tire. The bicyclist is then able to safely continue riding on the punctured tire. Additionally, the present invention overcomes the problem of air inflation using a manual pump that is inherent with tubeless tires.

The present invention is a practicle and valuable improvement in the design and manufacturing of bicycle tires for the tire industry. This new design is a break-through from the traditional bicycle tire concept.

What is claimed is:

1) The safety pneumatic tire for the bicycle comprises an improved tire and an improved inner tube which is incorporated inside the tire and both are mounted on a tubeless rim. The chamber between the improved tire, the improved inner tube and the tubeless rim is in an airtight environment that is totally isolated from the surrounding atmosphere. The characteristic of the improvements are that (i) beads of the improved tire is covered with an elastomeric layer to obtain a tight seal with the bead-seats of the tubeless rim, even in the situation where the inner tube is punctured, and (ii) an improved inner tube that utilizes various types of air valves (with and without elastic rubber covering) that connects with the rim valve hole completely to form a tight airtight seal.

2) The improved tire of the safety pneumatic tire as defined by claim 1, wherein the thickness, width or shape of or the material substance forming the elastomeric layer of said beads of the improved tire is nonrestrictive and may be varied and altered to increase the dependability and quality of the contact and seal at the juncture between the beads of the improved tire and the rim and to provide ease of installation of the improved tire onto the rim, including the optional addition or incorporation of a reinforcing strip in or along side said beads of the improved tire.

3) The improved inner tube of the safety pneumatic tire as defined by claim 1, wherein said the toroidal inner tube unites (through vulcanization or use of an adhesive) a semi elastic rubber covered air valve. The valve body which has incised spiral threads at its end section, is inserted into the rim valve hole and is held in place with sufficient tension to obtain an airtight seal between the valve body and the rim valve hole. One possible mechanism for creating sufficient and good tension between the valve body and rim valve hole is to employ a nut and washer at the outer side of the rim that screws onto the threads of the valve body that is inserted through the rim valve hole. The inserting base section of the air valve is covered an elastic rubber which diameter is reasonably greater than the inner diameter of the rim valve hole. Therefore, the screwing process becomes a pushing or clamping force that presses the elastic rubber covered section of the valve body into the valve hole and seals the valve hole completely.

4) The semi rubber covered air valve as defined in claim 3, wherein said structure or shape of, or material substance comprising, such semi rubber covered air valve is nonrestrictive and may be varied or altered to increase the dependability of sealing capacity with the rim valve hole, and also for ease of installation and secure positing of the improved inner tube onto the tubeless rim.

5) The improved inner tube of the safety pneumatic tire as defined by claim 1, wherein an alternative to an improved inner tube with an united semi elastic rubber covered air valve is the use of an air valve that is not united (through vulcanization or use of an adhesive) with the inner tube. The non-united valve base of the air valve is inserted into the tube air hole of the inner tube and anchors onto the inner side of the inner tube. The diameter of the base section of air valve should be reasonably greater than the inner diameter of the inner tube air hole and also should be greater than the inner diameter of the rim valve hole. Also, the edge of the inner tube around the tube air hole should be thickened or an elastic rubber O-ring should be added to inner side of the tube air hole. In addition, a tightly-fitting cone-shaped, nipple-shaped or other shaped elastic rubber ring piece may also be put on the valve body section close to the base of metal air valve but external to the inner tube. When the valve body is inserted through the rim valve hole and a mechanism is employed for providing sufficient and good tension between the valve body and the rim valve hole (such as a nut and the washer tightly screwed onto the threaded air valve section at the outer side of the rim), the base of the air valve compresses the edge of the inner tube air hole (thickened or with an elastic rubber O-ring) and a tightly-fitting cone-shaped, nipple-shaped or other shaped elastic rubber ring piece against the valve hole periphery to obtain an airtight seal between the valve body and rim valve hole. These sealing facilities allow the air valve to seal the tube air hole of the improved inner tube and to join the rim valve hole tightly.

6) The assembly using a non-united air valve in the improved inner tube as defined in claim 5, wherein the structure or shape, or material substance comprising, such non-united air valve or such thickened edge of the inner tube around the tube air hole or such elastic rubber O-ring or the assembly methodology of the foregoing are nonrestrictive and may be altered or varied for increasing the dependability of sealing capacity with the rim valve hole and for ease of installation of the inner tube onto the rim.

7) The safety pneumatic tire as defined in claim 1, wherein said the base of the elastic rubber covered air valve and inner tube are united (through vulcanization or use of an adhesive) to form one unit. The elastic rubber covered valve body section is to be inserted through the valve hole of the rim. Since the elastic rubber covered section is thicker in its diameter than the rim valve hole, the air valve body can be pressed into rim valve hole tightly to obtain the airtight sealing function. In addition, it is suggested that a notch in the elastic rubber covered section at the region near the base of air valve be formed so that, when the valve body is inserted and tightly squeezed into the valve hole periphery to the point of the notch, an airtight seal is obtained and the valve body is securely positioned and fastened to the rim valve hole.

8) The elastic rubber covered air valve and the diameter enlarged section thereof as defined in claim 7, wherein said the structure or shape of, or material substance comprising, such elastic rubber covered air valve or the diameter enlarged section thereof are nonrestrictive and may be altered or varied to increase the dependability of sealing and for an ease of installation of the inner tube onto the rim.

9) The safety pneumatic tire as defined in claim 1, wherein said safety pneumatic tire may also to be extended to apply on wheel chair tires.
